(19) United States
(12) Patent Application Publication
(10) Pub. No.: US 2020/0171439 A1
(43) Pub. Date: Jun. 4, 2020

(54) SINGLE USE ASEPTIC TANGENTIAL FLOW FILTRATION SYSTEMS AND METHODS

(71) Applicant: REPLIGEN CORPORATION, Waltham, MA (US)

(72) Inventors: Mark A. Perreault, Leominster, MA (US); John F. Connors, JR., Shrewsbury, MA (US); Paul C. Lowell, Wilmington, MA (US)

(73) Assignee: REPLIGEN CORPORATION, WALTHAM, MA (US)

(21) Appl. No.: 16/697,445

(22) Filed: Nov. 27, 2019

Related U.S. Application Data
(60) Provisional application No. 62/773,262, filed on Nov. 30, 2018.

(51) Int. Cl. B01D 63/08; B01D 65/00; B01D 65/02

(52) U.S. Cl. CPC B01D 63/082; B01D 65/003; B01D 65/022; B01D 2313/04; B01D 2321/346; B01D 2313/143; B01D 2313/58; B01D 2315/10; B01D 2313/146

(57) ABSTRACT

Cassettes for tangential flow filtration (TFF) are disclosed which reduce assembly and disassembly required for aseptic filtration. Packaging systems and methods for the TFF cassettes are also disclosed.

### PRIORITY

This application claims the benefit of priority under 35 USC § 119 to U.S. Provisional Application Ser. No. 62/773,262, filed Nov. 30, 2018, which is incorporated by reference herein in its entirety and for all purposes.

### FIELD OF THE DISCLOSURE

The present disclosure relates to tangential flow filtration systems and methods.

### BACKGROUND

Tangential flow filtration (TFF), also known as cross-flow filtration (CFF), is used throughout industry to separate or purify materials fluid suspensions or solutions based on their size differences. In a TFF system, a fluid feed comprising various molecular or particulate species flows into a filtration vessel in a direction perpendicular to a permeable membrane. In the filtration vessel, the feed is separated into two component flows: a permeate flow (also referred to as a filtrate) that passes through the membrane and includes certain species from the feed; and a retentate flow which does not pass through the membrane and includes any species that did not pass into the permeate.

TFF systems have several advantages over conventional direct-flow filtration systems, including generally lower rates of fouling due to filter cake formation for comparable membrane fluxes.

TFF systems are commonly implemented using plate-and-frame or cassette designs. These designs typically incorporate a plurality of flat sheet membranes arranged between external flat plates and manifolds. In use, a fluid feed is passed through the inlet of the manifold into the cassette, and tangentially to the first (upper) surfaces of the membranes. The permeate flow passes through the membranes then through the cassette into a dedicated permeate channel of the manifold, while the retentate does not cross the membrane and passes into a separate retentate channel of the manifold.

Conventionally, cassettes are made by interleaving multiple layers of membranes with pressure-sensitive adhesives (PSA) and screen mesh and, optionally, securing some or all of the layers together, e.g., by encapsulation using a silicone or urethane polymer. TFF cassettes generally include apertures or other features for interfacing with the manifold. Cassette designs can be susceptible to leaking when layers are mis-aligned with one-another or with the manifold interface. Thus, in use, cassettes are often sandwiched between flat plates or gaskets to seal the cassettes against such leakage.

In recent years, interest has grown in single-use aseptic TFF cassette systems for bioprocessing applications. Single use systems offer several potential advantages over multi-use systems, including lower costs for individual components and simplified workflows that do not include reprocessing and sterilization of cassettes. However, aseptic single use cassettes are often provided in formats that require some user assembly, e.g., assembly of a TFF “stack” comprising the cassette and flat plates for sealing the cassette. These designs are straightforward and effective, but some potential exists for failure due to defects in the plates or user error in their assembly. Reduction of these risks could result in cost savings and avert losses due to cassette failures.

### SUMMARY

The present disclosure provides single-use TFF cassettes and methods for making and using them which offer reduced risk of failure and reduced user assembly. One aspect of this disclosure relates to a tangential flow filtration cassette comprising a flexible isolation plate, at least one of a gasket and a filter plate, and a stack of interleaved layers disposed between the flexible isolation plate and the gasket or filter plate, which layers define at least one feed channel and at least one filtrate channel. The plurality of interleaved layers includes a filtrate channel spacer which defines an open interior volume bounded by an interior perimeter and which includes one or more fluid ports, a non-flexible feed channel spacer also defining an open interior volume bounded by an interior perimeter and also including one or more fluid ports, and a membrane disposed between the feed and filtrate channel spacers. The layers also optionally include a pressure sensitive adhesive binding together the membrane and one of the filtrate channel spacer and the feed channel spacer, said thin film of pressure sensitive adhesive having a thickness of less than 50% of height of an adjacent channel. The flexible isolation plate comprises a flexible polymer or a thermoplastic elastomer and is bonded to a first surface of the stack of interleaved layers. In various embodiments, a gasket is bonded to a second surface of the stack of interleaved layers, which gasket comprising separate fluid ports for the feed and filtrate channels, and a filter plate comprising a fluid manifold is optionally bonded to the gasket such that a feed port of the filter plate is aligned with a feed port of the gasket, and a filtrate port of the filter plate is aligned with a filtrate port of the gasket. In some embodiments, the TFF cassette includes a tab or an engraving on a sidewall of the cassette to identify the TFF cassette by one or more of a stock keeping unit (SKU) number, a lot number, a serial number, a capacity, a number of feed and/or filtrate channels, and a number of membranes. The tab or engraving may include a barcode. In some instance, the TFF cassette is disposable and/or comprises a sealed edge. In some cases, the feed channel and/or the filtrate channel includes a screen disposed within the space defined by the channel spacer. The screen may include a woven or polymer mesh.

In another aspect, the disclosure relates to a TFF cassette comprising a plurality of filtrate channels, with each filtrate channel comprising, from top to bottom, a first filter membrane; a middle comprising a polymer screen disposed within a cured-in-place urethane perimeter seal; and one of a second filter membrane or a flat plastic member, wherein each of the first filter membrane and the second filter membrane or flat plastic member comprise a feed port, and wherein the middle optionally comprises a cured-in-place urethane seal separating the polymer screen from at least one feed port. In some embodiments, the cassette also comprises a plurality of feed channels disposed in an alternating manner with the filtrate channels, each feed channel comprising a channel spacer disposed within the urethane perimeter seal, and the channel spacer optionally comprise first and second pressure-sensitive adhesive (PSA) layers for bonding the channel spacer to the first filter membrane and the second filter membrane or flat plastic member. The PSA layers may be 0.002-0.005 inch (0.051-0.127 mm) in thickness in some cases, while the flat plastic member can be 0.010-0.030 inch (0.254-0.762 mm) in thickness.

In yet another aspect, this disclosure relates to a system for shipping a tangential flow filtration (TFF) cassette, comprising a TFF cassette disposed in a sealed package that may include a single layer or multiple layers. The one or more layers of the package may comprise, e.g., thermoplastic polyurethane, polyolefin ethylene vinyl acetate, SBS block copolymers, polyester elastomers, or the like. A packaged system can be sterilized by gramma irradiation.

In various embodiments described here or otherwise, the package may comprise a plurality of layers. The package may comprise thermoplastic polyurethane, polyolefin, ethylene vinyl acetate, SBS block copolymers, polyester elastomers, or a combination thereof. The package may comprise a sheet formed into a heat-shrink sleeve. The TFF cassette may comprise a flexible isolation plate, at least one of a gasket and a filter plate, and a plurality of interleaved layers disposed between the flexible isolation plate and the gasket or filter plate, the plurality of interleaved layers defining at least one feed channel and at least one filtrate channel.

### BRIEF DESCRIPTION OF THE DRAWINGS

FIG. 1 depicts a laminated cassette design according to an embodiment of the disclosure.

FIG. 2 depicts an exploded view of feed and filter channels according to an embodiment of the disclosure.

FIG. 3 depicts an exploded view of a tangential flow filtration system according to an embodiment of the disclosure.

FIG. 4 depicts a perspective view of a tangential flow filtration system according to an embodiment of the disclosure.

FIG. 5 depicts side and cutaway views of a laminated cassette design according to an embodiment of this disclosure.

FIG. 6 depicts a packaged single-use cassette according to an embodiment of this disclosure.

### DETAILED DESCRIPTION

### Laminated Cross-Flow Filtration Cassettes

The present disclosure features a laminated cross-flow filtration cassette that utilizes (a) polymer channel seals and/or (b) pre-formed channel spacers coated with a thin film of adhesive, such as hot melt or PSA tape, to bond and encapsulate the alternating layers of membranes and channel spacers. When so bound, the channel spacers create precisely defined fluid flow boundaries for the channels.

A filtration cassette of this disclosure may be used in a variety of small and large-scale applications requiring cross-flow filtration and may be particularly suitable in small and large scale pharmaceutical and biopharmaceutical filtration processes including, but not limited to, the production of vaccines, monoclonal antibodies, and patient-specific treatments.

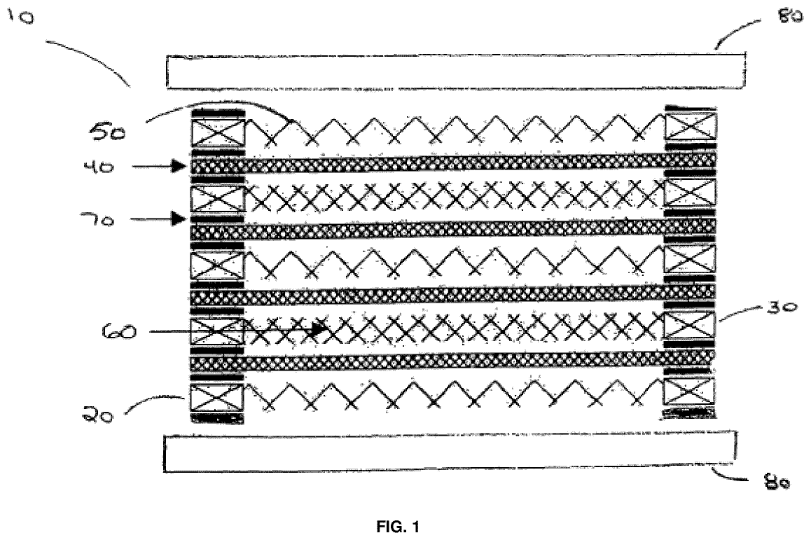

A cross-sectional view of one embodiment of a laminated cross-flow filtration cassette utilizing only pre-formed PSA-coated channel spacers is generally shown in FIG. 1. Filtration cassette 10 includes one or more filtrate channel spacers 20, one or more feed channel spacers 30, and one or more membranes 40. The number of channel spacers and membranes included in a filtration cassette can be influenced by the capacity requirements for the filtration cassette. In general the number of membranes can be twice the number of feed channel spacers. The number of filtrate channel spacers can be equal to the number of feed channel spacers or the number of feed channel spacers plus one. However, a cassette can be constructed with only one membrane, one filtrate channel spacer and one feed channel spacer, or other numbers of membranes and spacers.

The total number of membranes within a cassette can be from 1 to 1000 or more, preferably from 1 to 500, and more preferably from 1 to 250. The total number of feed channel spacers within a cassette can be from 1 to 500 or more, preferably from 1 to 250, and more preferably from 1 to 125. The total number of filtrate channel spacers within a cassette can also be from 1 to 500 or more, preferably from 1 to 250, and more preferably 1 to 125. For example, a small cassette can have 2 membranes, 1 feed channel spacer and 2 filtrate channel spacers. A 1× cassette can have 22 membranes, 11 feed channel spacers and 12 filtrate channel spacers. A 5× cassette can have 110 membranes, 55 feed channel spacers and 56 filtrate channel spacers. A 10× cassette can have 220 membranes, 110 feed channel spacers and 111 filtrate channel spacers. A 20× cassette can have 440 membranes, 220 feed channel spacers and 221 filtrate channel spacers, etc.

Membranes 40 are positioned between feed channel spacers 30 and filtrate channel spacers 20. Filtration cassette 10 also preferably includes one or more filtrate screens 50 inserted into the open interior volume of filtrate channel spacers 20. Filtration cassette 10 can further include one or more feed screens 60, inserted into an open interior volume of feed channel spacers 30. Preferably, each of the open interior volumes of the filtrate channel spacers 20 and the feed channel spacers 30 have one filtrate screen 50 or feed screen 60. The screens 50, 60 can fill the area defined by the membranes 40 and the spacers 20, 30, while still facilitating the flow of feed or filtrate therethrough. The screens may also serve other purposes, such as that of an additional filtration means or preventing compression of the cassette by keeping the channel volume relatively constant. A thin film of adhesive 70 is used to bind the alternating layers of filtrate channel spacers 20, membranes 40, and feed channel spacers 30. Filtration cassette 10 can further include one or more, preferably two, end plates 80.

Thin film of adhesive 70 can be a hot melt adhesive, such as a polymeric adhesive, or PSA, such as a silicone-, acrylic- or synthetic rubber-based PSA. A PSA may be in the form of a transfer tape applied to a polysulfone or polyolefin carrier. The term “pressure-sensitive adhesive” or “PSA” means a bonding agent that remains tacky and ready for use after curing. Other suitable bonding agents that may be used to form the thin film of adhesive include, but are not limited to, one- or two-part adhesives, UV or electron beam curable materials, or other bonding materials capable of being applied as a thin coating. For many applications, the thin film of adhesive can be approximately 0.020 inches (about 500 μm) or less. PSAs with a thickness in the range of approximately 0.002 inches (about 50 μm) to approximately 0.005 inches (about 130 μm) are preferred.

The use of thin films of adhesive in the filtration cassette of the present invention may eliminate or reduce the leaching and extraction problems associated with undesired contaminants in prior single and two-part urethane and silicone systems. The use of a thin film of adhesive may also eliminate the need for the cosmetic edge found on traditional cassettes, and thus may reduce the amount of adhesive used during assembly by as much as seventy-five (75) percent. In addition, the use of thin films of adhesive in the present invention may facilitate more efficient or cost-effective manufacturing, at least in part because spacers having thin films of adhesive are more convenient to use than liquid urethane or silicone encapsulation systems. Further, when PSA is used as the thin film of adhesive, the curing time may be reduced or eliminated, and the build cycle may be shortened from two to three days for a traditional cassette to one day for a filtration cassette of the present invention. The use of spacers and thin films of adhesive may also permit taller cassette heights, eliminating the problems associated with varying encapsulant viscosities, and reducing the number of gaskets needed in production.

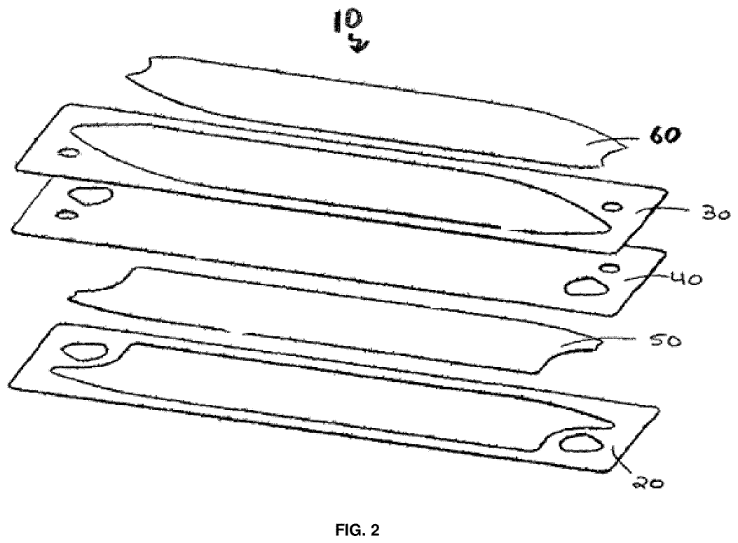

The components of filtration cassette 10 are further shown in FIG. 2. Filtrate channel spacer 20 and feed channel spacer 30 are preferably made of polypropylene, although any material that can be supplied in sheet or film form and cut to the required size and shape, including but not limited to high density polyethylene (HDPE), low density polyethylene (LDPE), polysulfone, polyketones (PEEK), nylon, and PolyVinylidine DiFlouride (PVDF), is contemplated and within the scope of the invention. Channel spacers 20 and 30 are preferably die-cut, although other methods of manufacture that result in uniform shape and tight tolerance, including but not limited to machining, stamping, and molding, are contemplated and within the scope of the invention. As a result, the channels of the laminated cassette of the present invention may be highly defined and may not be subject to the disadvantages resulting from the use of urethane or silicone encapsulation systems. In addition, the use of die-cut spacers may reduce material handling during manufacturing and facilitate automated or robotic assembly.

Channel height is defined primarily by the thickness of channel spacers 20 and 30, and to a lesser degree by the thickness of thin film of adhesive 70. In general, the formula for determining the channel height is, C=S+2A, where C is the channel height, S is the thickness of channel spacer 20 or 30, and A is the thickness of thin film of adhesive 70. Channel height is preferably in the range of approximately 0.010 inches (about 0.25 mm) through approximately 0.10 inches (about 2.5 mm), although in other embodiments, channel heights can be as small as approximately 0.004 inches (about 0.1 mm) or as large as approximately 12 inches (about 30 cm). By adjusting the thickness of channel spacers 20 and 30, channel height may be selectively defined to within very tight tolerances.

With further reference to FIGS. 1 and 2, filtrate screen 50 and feed screen 60 may be made of woven polypropylene, although other woven or extruded meshes made of polyester, polyamide, nylon, polyetheretherketone (PEEK), and Teflon-based materials such as ethylene tetrafluoroethylene (ETFE), or blends of any of these materials, are contemplated and within the scope of the invention. Screens 50 and 60 can be die-cut, although other methods of manufacture, including machining, stamping, or molding, are contemplated and within the scope of the invention. In addition, the use of die-cut screens may reduce material handling during manufacturing and facilitate automated or robotic assembly. Filtrate screen 50 and feed screen 60 are optionally inserted into an open interior volume of filtrate channel spacer 20 and feed channel spacer 30, respectively. Screens 50 and 60 can create turbulence, which minimizes gel layer formation while improving fluid velocity at the membrane surface. A build-up of the gel layer may cause the membrane to foul, resulting in reduced membrane flux. Filtrate screen 50 can also provide support for membrane 40 and act as an under drain to facilitate the flow of fluid out of filtration cassette 10.

If feed screen 60 is not used, the feed channel is left open and flowing. Without a screen, however, a higher pumping capacity may be required to achieve the same fluid velocity at the membrane surface as would be achieved with a screen for the same channel height. In general, screens 50 and 60 act as a turbulence promoter to minimize fouling while reducing the total fluid volume passing through a channel. A lesser flow, in turn, requires less pumping. In general, low viscosity fluids are better suited to channels with a relatively low channel height and screens, while high viscosity fluids are better suited to channels with a relatively high channel height with no screens or more open screens.

In some cases, screens 50 and 60 are sized to “float” in the channel, i.e., screens 50 and 60 are each have a thickness that does not exceed the total channel height created by the combination of channel spacer 20 or 30 and thin film of adhesive 70. A “floating” screen does not impinge on membrane 40 and may result in less debris build-up under the screen.

Alternatively, screens 50 and 60 and channel spacers 20 and 30 can be sized such that the screen thickness is greater than the channel height, such that the screen is pressed into the membrane to mimic traditional cassette technology. In other embodiments, screens or turbulence promoters (not shown) may be molded into channel spacers 20 and 30.

With further reference to FIGS. 1 and 2, membrane 40 includes ports for feed, retentate and filtrate, although different numbers and configurations of ports, including but not limited to having only one filtrate port, or having multiple feed and retentate ports, are contemplated and within the scope of the invention. Membrane 40 is preferably made of modified polyethersulfone or regenerated cellulose, although any semi-permeable sheet material, including but not limited to ultrafiltration, microporous, nanofiltration or reverse osmosis filters formed from polyvinylidene fluoride (PVDF), polysulfone, polyethersulfone, regenerated cellulose, polyamide, polypropylene, polyethylene, polytetrafluoroethylene, cellulose acetate, polyacrylonitrile, vinyl copolymer, polycarbonate, and blends of these materials, are contemplated and within the scope of the invention. Membranes 40 may be die-cut, although other methods of manufacture, including machining, stamping, or molding, are contemplated and within the scope of the invention. In addition, the use of die-cut membranes may reduce material handling during manufacturing, and facilitate automated or robotic assembly. The membrane pore size rating is preferably in the range of approximately 1,000 Dalton through approximately 1 micron, although in other embodiments, pore size ratings may be from less than approximately 100 Dalton to approximately 3 micron.

### Sealed Single-Use TFF Cassettes

One group of embodiments in this disclosure relates to pre-assembled, single-use irradiated TFF cassette systems that differ from existing systems in their incorporation of end-plates and/or gasket structures that have previously been provided separately and assembled by end users. The embodiments described herein are advantageous in that they are closed systems, they eliminate at least one user assembly step prior to use and/or at least one disassembly step after use. Elimination of a disassembly step in particular may reduce end-user exposure to biohazardous materials captured by the filter during operation. Additionally, this design assures that the TFF cassette remains aseptically sealed and isolated from the environment, preventing contamination of the cassette.

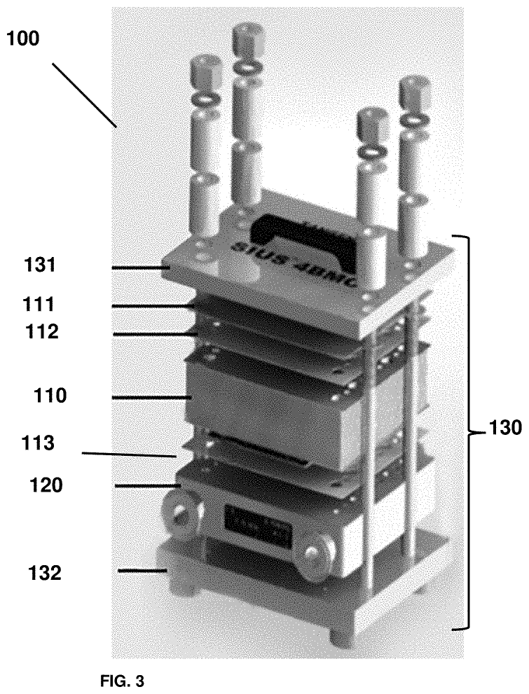

FIG. 3 depicts a standard TFF system 100 which includes a TFF cassette 110, a filter plate insert 120, and a clamp 130 comprising a top plate 131 and a bottom plate 132. Between the top plate 131 and the TFF cassette 110 are disposed one or more of a flexible non-perforated flexible isolation plate 111 and an elastomeric gasket 112 comprising one or more ports to accommodate the flow of fluid there through. Between the TFF cassette 110 and the filter plate insert 120 another elastomeric gasket 113 is disposed. In this system, each of the elastomeric gaskets 112, 113 and the flexible isolation plate 111 ensure separation of feed, retentate and permeate flows and confine these flows to the cassette 110 and the filter plate insert 120. If the flexible isolation plate 111 and/or an elastomeric gasket 112, 113 is omitted or misaligned, fluid leakage and/or contamination may occur. Importantly, if the surface of the cassette is slightly irregular or not completely flat, the flexible isolation plate will remain sealed when no compressive force is applied to the cassette stack.

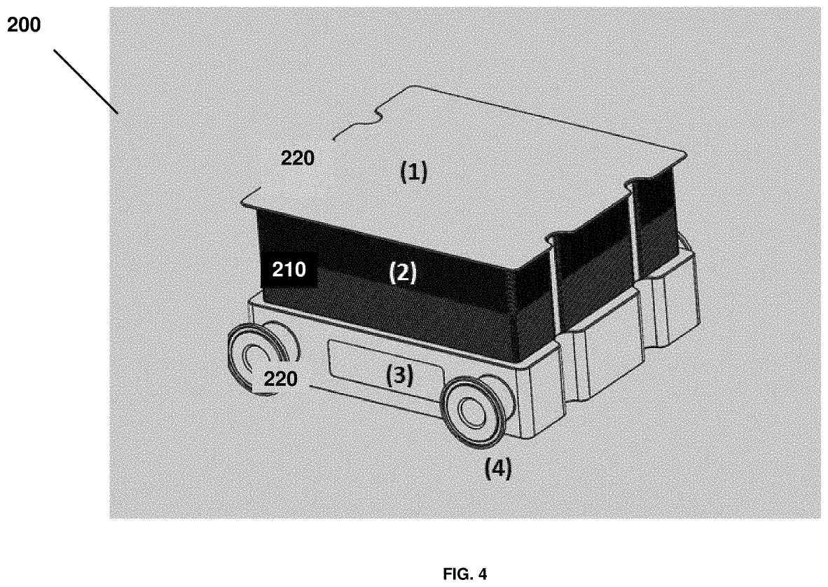

Turning to FIG. 4, an exemplary TFF cassette 200 according to the present disclosure includes a stack 210 of 1-1000 (e.g., 1-10, 10-100, 100-250, etc.) interleaved membranes and channel spacers (e.g., comprising a pressure-sensitive adhesive material) defining alternating feed and filtrate channels. Optionally, screens are disposed in the feed and/or filtrate channels.

Atop the TFF cassette 200, a flexible isolation plate 220 is disposed to fluidly seal the cassette. The flexible isolation plate 220 may comprise a flexible polymer such as a saturated rubber, an unsaturated rubber, and/or a thermoplastic elastomer, and may range in thickness from 0.005 inch to 0.250 inch (0.127 to 6.35 mm). The flexible isolation plate according to this disclosure is flexible enough to conform to uneven regions or irregularities in the upper surface of the TFF cassette 200, ensuring a robust seal there between. The flexible isolation plate 220 is solid—i.e., non-porous and non-perforated—to limit fluid flows therethrough. In some cases, a bond is created between the flexible isolation plate 220 and the cassette 200 to ensure uniform sealing therebetween. The bond may be made in any suitable way, including without limitation using a PSA, a thermosetting adhesive, or a multi-part adhesive formulation. The bond, like the flexible isolation plate 220 itself, conforms to uneven regions or irregularities in the upper surface of the cassette 200.

At the bottom, the TFF cassette 200 is mated, variously, to a gasket (not shown) or directly to a manifold 300, also referred to as a filter plate. The manifold 300 is manufactured using any suitable polymer, including without limitation polypropylene, high-density polyethylene (HDPE), or engineering-grade plastics. Manifold 300 is molded or machined to match the aperture layout and sealing surface of of the TFF cassette 200. The manifold may be between 0.25 and 4.00 inches thick (6.35 to 102 mm).

TFF Cassettes with Polymer Filtrate Channel Seal.

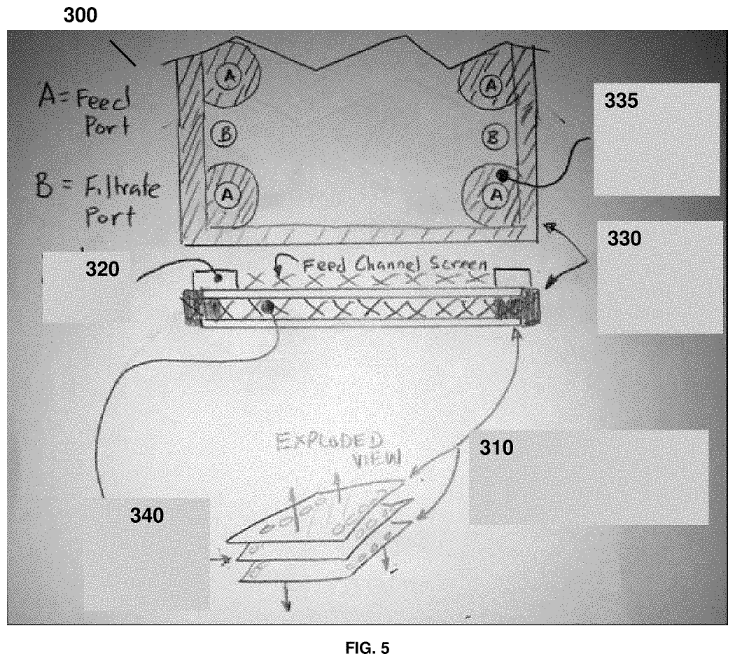

In another aspect of this disclosure, some or all of the filtrate channels of a TFF cassette incorporate a polymer (e.g., urethane) seal about at least a portion of the perimeter of the channel, and a polymer seal about feed and/or filtrate ports to prevent contamination of the filtrate channel with feed or retentate material. As shown in FIG. 5, an exemplary design for a TFF cassette 300 comprises interleaved stacks of filter membranes 310, feed channel spacers 320, perimeter seals 330, feed channel seals 335, and optional feed channel screens 340 and/or filtrate channel screens 345. This arrangement results in alternating feed channels 360 and filtrate channels 370, wherein the filtrate channels 370 include a perimeter seal 330, while the feed channels 360 incorporate a pre-formed channel spacer 320. Stacks according to this aspect of the disclosure may be formed by (a) forming the filtrate channels 370 by sandwiching a filtrate channel screen 345 with two filter membranes 310 and applying a bead of a curable polymer (e.g., a urethane) to the perimeter of the sandwich. Optionally, a negative pressure is applied to the sandwich to facilitate infiltration of the polymer bead and ensure a secure bond. In step (b), feed channels formed in step (a) are assembled in an alternating stack with feed spacers 320 and, optionally, feed channel screens 340 to form a cassette. Additional finish steps are optional and may include, variously, adhering a tab or other marker to identify the cassette or a feature thereof, or applying (e.g., by overmolding, pouring or casting-in-place) a polymer layer about the edge of the completed stack to form a uniform edge.

Feed channel spacers 320 may comprise a gasket formed of a flexible or semi-rigid material that is bonded to the adjacent membranes via e.g., a pressure sensitive adhesive material as described above. The flexible or semi-rigid material is generally between 0.005 and 0.060 inch (0.127-1.52 mm) in thickness, while the PSA may be 0.002-0.005 inch (0.051-0.127 mm) in thickness.

In certain embodiments, the perimeter seals 330 may comprise a flexible polymer such as urethane, and function to seal the perimeter of each filtrate channel and are formed by applying urethane to an exterior or an edge of the filtrate layer during the stacking process, or alternatively by applying a urethane coat to the filtrate channels following stacking. Feed port seals 335 may be formed by applying urethane (e.g. as an uncured urethane bead) around at least a portion of the circumference of the feed channel.

In some cases, the feed channel is formed, on one side, by a filter membrane 310, while the other side is formed by a plastic sheet. (not shown). The plastic sheet may be 0.010-0.030 inch (0.254-0.762 mm) in thickness.

### Thermoplastic Polyurethane Packaging of Aseptic TFF Cassettes

One challenge in producing aseptic TFF cassettes is bagging such cassettes in a material that can withstand harsh sterilization conditions and can retain structural integrity during shipping and storage. The inventors have found that packaging an embodiment of a cassette of this disclosure may include a sealed package. In various embodiments, a sealed package may include a single layer or multiple layers. One or more layers of a package may comprise, e.g., thermoplastic polyurethane, polyolefin, ethylene vinyl acetate, SBS block copolymers, polyester elastomers, or the like. A packaged system can be sterilized by gramma irradiation. Multiple materials such as thermoplastic elastomers may be chosen for packaging. Qualities of a material for the one or more layers of a packaging may include abrasion resistance, flexibility at low temperatures, resistance to hydrolysis and/or microbial infiltration, a combination thereof, or the like. For example, a desirable packaging may comprise materials or a construction able to withstand 1 atmosphere of fluid pressure or withstand a corrosive storage solution (e.g., 0.2M NaOH). One thermoplastic polyurethane material, e.g., is an aromatic polyether polyurethane sheet commercialized by Covestro LLC (Deerfield, Mass.) and sold under the name Dureflex® PT9500.

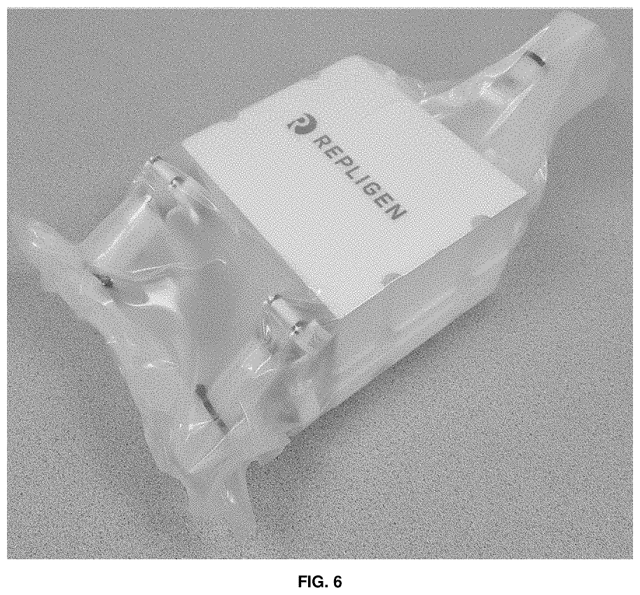

In various embodiments, one or more sheets of a packaging comprising a material described herein may be formed into a sleeve, and a TFF cassette may be placed within the sleeve. The sleeve is optionally heated to heat-shrink and/or to seal the sleeve prior to sterilization of the bagged TFF cassette within the packaging by gamma irradiation or other suitable means. A representative bagged TFF cassette within packaging is shown in FIG. 6.

### CONCLUSION

All publications, patents, and patent applications mentioned herein are hereby incorporated by reference in their entirety as if each individual publication, patent or patent application was specifically and individually indicated to be incorporated by reference. In case of conflict, the present application, including any definitions herein, will control. Those skilled in the art will recognize or be able to ascertain using no more than routine experimentation, many equivalents to the specific embodiments described herein. Such equivalents are intended to be encompassed by the following claims.

1. A tangential flow filtration (TFF) cassette, comprising:
a flexible isolation plate;
at least one of a gasket and a filter plate; and
disposed between the flexible isolation plate and the gasket or filter plate, a stack of interleaved layers defining at least one feed channel and at least one filtrate channel, the plurality of interleaved layers comprising:
a filtrate channel spacer defining an open interior volume bounded by an inner perimeter and including one or more fluid ports;
a non-flexible feed channel spacer defining an open interior volume bounded by an inner perimeter and including one or more fluid ports;
a membrane disposed between the filtrate channel spacer and the feed channel spacers; and, optionally,
a pressure sensitive adhesive binding together the membrane and one of the filtrate channel spacer and the feed channel spacer, said thin film of pressure sensitive adhesive having a thickness of less than 50% of height of an adjacent channel;
wherein (a) the flexible isolation plate comprises a flexible polymer or a thermoplastic elastomer and is bonded to a first surface of the stack of interleaved layers.

2. The TFF cassette of claim 1, wherein a gasket is bonded to a second surface of the interleaved stack, the gasket comprising separate fluid ports for the feed and filtrate channels.

3. The TFF cassette of claim 2, wherein a filter plate is bonded to the gasket, the filter plate comprising a fluid manifold wherein a feed port of the filter plate is aligned with a feed port of the gasket, and a filtrate port of the filter plate is aligned with a filtrate port of the gasket.

4. The TFF cassette of claim 1, further comprising a tab or an engraving on a sidewall of the cassette to identify the TFF cassette by one or more of a stock keeping unit (SKU) number, a lot number, a serial number, a capacity, a number of feed and/or filtrate channels, and a number of membranes.

5. The TFF cassette of claim 1, wherein the tab or engraving comprises a barcode.

6. The TFF cassette of claim 1, wherein the TFF cassette is disposable after use.

7. The TFF cassette of claim 1, wherein the TFF cassette comprises a sealed edge.

8. The TFF cassette of claim 1, wherein the at least one feed channel comprises a feed screen disposed within a space defined by the feed channel spacer.

9. The TFF cassette of claim 8, wherein the feed screen comprises a woven or extruded polymer mesh.

10. The TFF cassette of claim 1, wherein the at least one filtrate channel comprises a filtrate screen disposed within a space defined by the filtrate channel spacer.

11. The TFF cassette of claim 10, wherein the filtrate screen comprises a woven or extruded polymer mesh.

12. A TFF cassette comprising a plurality of filtrate channels, each filtrate channel comprising, from top to bottom
a first filter membrane; a middle comprising a polymer screen disposed within a cured-in-place urethane perimeter seal; and one of a second filter membrane or a flat plastic member, wherein each of the first filter membrane and the second filter membrane or flat plastic member comprise a feed port, and wherein the middle optionally comprises a cured-in-place urethane seal separating the polymer screen from at least one feed port.

13. The TFF cassette of claim 12, further comprising a plurality of feed channels disposed in an alternating manner with the filtrate channels, each feed channel comprising a channel spacer disposed within the urethane perimeter seal, and the channel spacer optionally comprise first and second pressure-sensitive adhesive (PSA) layers for bonding the channel spacer to the first filter membrane and the second filter membrane or flat plastic member.

14. The TFF cassette of claim 13, wherein the first and second PSA layers are between 0.002 inches and 0.005 inches in thickness.

15. The TFF cassette of claim 12, wherein the flat plastic member is between 0.010 inches and 0.030 inches in thickness.

16. A system for shipping a tangential flow filtration (TFF) cassette, comprising a TFF cassette disposed in a sealed package, wherein the system is configured to be sterilized by gramma irradiation.

17. The system of claim 16, wherein the package comprises a plurality of layers.

18. The system of claim 16, wherein the package comprises thermoplastic polyurethane, ethylene vinyl acetate, SBS block copolymers, polyester elastomers, or a combination thereof.

19. The system of claim 16, wherein the package comprises a sheet formed into a heat-shrink sleeve.

20. The system of claim 16, wherein the TFF cassette comprises:
a flexible isolation plate;
at least one of a gasket and a filter plate; and
a plurality of interleaved layers disposed between the flexible isolation plate and the gasket or filter plate, the plurality of interleaved layers defining at least one feed channel and at least one filtrate channel.
